(19) United States
(12) Patent Application Publication
(10) Pub. No.: US 2016/0185682 A1
(43) Pub. Date: Jun. 30, 2016

(54) NITRIFICATION INHIBITOR COMPOSITIONS AND METHODS FOR PREPARING THE SAME

(71) Applicant: Dow AgroSciences LLC, Indianapolis, IN (US)

(72) Inventor: Joshua S. Katz, Merion Station, PA (US)

(21) Appl. No.: 14/982,891

(22) Filed: Dec. 29, 2015

Related U.S. Application Data
(60) Provisional application No. 62/098,879, filed on Dec. 31, 2014.
(60) Provisional application No. 62/098,889, filed on Dec. 31, 2014.
(60) Provisional application No. 62/098,895, filed on Dec. 31, 2014.

(51) Int. Cl. C05G 3/08; C05G 3/00; C05D 9/02; C05D 1/00; C05C 11/00; C05C 9/00; C05B 17/00

(52) U.S. Cl. CPC C05G 3/08; C05C 9/005; C05G 3/0029; C05B 17/00; C05D 1/005; C05C 11/00; C05D 9/02

(57) ABSTRACT

The present disclosure relates to enhanced nitrification inhibitor dry fertilizer compositions, methods for making the same, and their use in agricultural applications.

### CROSS REFERENCE TO RELATED APPLICATIONS

This application claims priority to U.S. Provisional Patent Application Ser. Nos. 62/098,879, 62/098,889, and 62/098,895, all filed Dec. 31, 2014, the disclosures of which are hereby expressly incorporated by reference herein in their entirety.

### FIELD

The present disclosure relates to compositions that inhibit nitrification and methods of making the same. In some aspects, these compositions are formulated to include other agriculturally active compounds, such as nitrogen-rich fertilizers.

### BACKGROUND AND SUMMARY

Nitrogen fertilizer added to the soil is readily transformed through a number of undesirable biological and chemical processes, including nitrification, leaching, and evaporation. Many transformation processes reduce the level of nitrogen available for uptake by the targeted plant. The decrease in available nitrogen requires the addition of more nitrogen rich fertilizer to compensate for the loss of agriculturally active nitrogen available to the plants. These concerns intensify the demand for improved management of nitrogen for economic efficiency and protection of the environment. Nitrification is the process by which certain widely occurring soil bacteria metabolize the ammonium form of nitrogen in the soil transforming the nitrogen into nitrite and nitrate forms, which are more susceptible to nitrogen loss through leaching or volatilization via denitrification.

Methods for reducing nitrification include treating soil with agriculturally active compounds that inhibit or at least reduce the metabolic activity of at least some microbes in the soil that contribute to nitrification. These compounds include (Trichloromethyl)pyridines, such as nitrapyrin, which have been used as nitrification inhibitors in combination with fertilizers as described in U.S. Pat. No. 3,135,594, the disclosure of which is incorporated herein by reference in its entirety. These compounds help to maintain agriculturally-applied ammonium nitrogen in the ammonium form (stabilized nitrogen), thereby enhancing plant growth and crop yield. These compounds have been used efficaciously with a number of plant crops including corn, sorghum, and wheat.

Compounds such as nitrapyrin are unstable in soil in part because they are very volatile. For example, nitrapyrin has a relatively high vapor pressure (2.8×10⁻³ mm Hg at 230 Celsius), and because of this it has a tendency to volatilize and must be applied immediately or somehow protected from rapid loss after the fertilizer is treated with nitrapyrin. One approach is to add nitrapyrin to a volatile fertilizer, namely anhydrous ammonia which itself must be added to the soil in manner that reduces the amount of the volatile active lost to the atmosphere. This method is problematic in that it requires the use of anhydrous ammonia, which is corrosive and must be injected into the soil. This application method, while stabilizing nitrapyrin below the soil surface, is not preferred or is completely unsuitable for many other fertilizer types and their application practices such as dry fertilizer granules, which most often are broadcasted onto the soil surface.

Still other approaches to stabilize nitrapyrin include applying it to the surface of the soil and then mechanically incorporating it into the soil, or watering it into the soil generally within 8 hours after its application to reduce its loss to the atmosphere. Encapsulated nitrapyrin for rapid or dump release have been formulated with lignin sulfonates as disclosed in U.S. Pat. No. 4,746,513, the disclosure of which is incorporated herein by reference in its entirety. Unfortunately, these formulations are difficult and costly to produce, and while these formulations are less volatile than simple nitrapyrin, these formulations are more effectively used with liquid urea ammonium nitrate (“UAN”) or liquid manure fertilizers than with dry fertilizers.

Another approach to stabilizing nitrapyrin includes polycondensation encapsulation. Additional information regarding this approach can be found in U.S. Pat. No. 5,925,464, the disclosure of which is incorporated herein by reference in its entirety. Some of these formulations enhance handling safety and storage stability of the nitrapyrin using polyurethane rather than polyurea to form at least a portion of the capsule shell.

In some instances, polyurea has been used to produce enhanced nitrification inhibitor compositions for delayed, steady release of nitrification inhibitors for application with fertilizers. Such encapsulated forms of nitrapyrin are disclosed in U.S. Pat. No. 8,377,849 and U.S. Pat. No. 8,741,805, the disclosures of which are incorporated herein by reference in their entirety.

Independent application of nitrification inhibitors such as nitrapyrin has some drawbacks. Many farmers are reluctant to separately apply a nitrogen fertilizer and a nitrification inhibitor composition because: (1) such separate application consumes considerable time and human resources, (2) there is a large potential for non-uniform distribution of nitrapyrin, which may lead to performance loss and ineffective use of nitrapyrin; and (3) there is an uncontrolled fertilizer to inhibitor ratio in soil, which may lead to performance loss.

Accordingly, nitrapyrin and nitrogen-based fertilizers may be applied at the same time by mixing the compounds and applying them from a common reservoir. Premixing many formulations of nitrapyrin with fertilizers also has certain disadvantages, including: (1) extra time, human resources, and cost in the premixing process; (2) difficulty in combining dry fertilizer granules, such as, for example, urea granules, with nitrapyrin products most commonly sold in emulsifiable concentrate (“EC”) or capsule suspension (“CS”) liquid form; (3) large differences in application rates, which make preparation of homogeneous blends difficult, for example, the application rate of nitrogen fertilizers (in some embodiments about 20-50 kg/Mu, such as, for example, urea) is hundreds of times that of nitrification inhibitors such as nitrapyrin (for example Entrench®, which is about 170 ml/Mu); and (4) only temporary stability against volatilization loss for nitrapyrin products, commercially available as, for example, Instinct® or Entrench®, when impregnated onto fertilizer granules, such as, for example, urea. Such fertilizer product must be applied shortly after impregnation to minimize the loss of performance.

Furthermore, water in many preparations of nitrapyrin may cause problems such as the attachment and crystallization of urea particles, and therefore there is an advantage to avoiding use of liquid concentrates (EC or CS) of nitrapyrin with nitrogen fertilizer granules, such as urea.

While considerable progress has been made in the delivery and stability of nitrification inhibitors such as nitrapyrin, there remains a need for still more efficacious formulations of compounds such as (trichloromethyl)pyridines. There remains a special need for compositions that effectively include at least one agriculturally active ingredient (“AI”) in addition to the nitrification inhibitor that that can be applied along with agricultural actives such as nitrogen fertilizers without the need for additional mixing and/or application steps.

Some aspects of the disclosure include compositions that include one or more nitrogen fertilizers with one or more nitrification inhibitors. In some embodiments, encapsulated nitrapyrin is coated on fertilizer particles or granules and/or inert particles or granules, and is encapsulated by a polymeric material which reduces volatilization, optionally with one or more particulates, optionally hygroscopic particulate, and optionally inorganic hygroscopic particulates. Such dry fertilizer/nitrification inhibitor compositions increase ease-of-use, exhibit controlled release of nitrification inhibitor and nitrogen, increase fertilizer efficiency, and decrease pollution of the soil, water, and air through reduced nitrification. Some of the inventive compositions disclosed herein also exhibit good nitrapyrin stability even at elevated temperatures.

In some embodiments of the present disclosure, material which reduces volatilization are used to prevent and/or reduce the volatilization of nitrification inhibitors during and after manufacturing, processing, storage, and/or while in use on the surface of a field, in soil, in a crop, and/or in a flooded rice paddy.

In some embodiments, the volatilization-reducing barriers enable rapid release of nitrification inhibitors into the adjacent environment upon contact with a suitable level of moisture. In some preferred embodiments, the volatilization-reducing barriers release one or more nitrification inhibitors and/or agriculturally active ingredients (“AI's”) into the adjacent environment when the volatilization-reducing barriers encounter moisture from rainfall, irrigation, and/or moisture in a field, crop, and/or flooded rice paddy.

In some embodiments, the volatilization-reducing barriers comprise polyvinyl alcohol (“PVA” or “PVOH”). In some preferred embodiments, the volatilization-reducing barriers prevent the volatilization of (Trichloromethyl)pyridines. In some embodiments, the volatilization-reducing barrier reduces the volatilization of nitrapyrin.

Some embodiments of the disclosure include granules of urea. Still other embodiments may include other fertilizers such as other formulations of nitrogen, and/or phosphorous, and/or potassium, and/or combinations of two or more or all three (“NPK”) fertilizers, and/or bulk blends of fertilizers. In some embodiments, compounding fertilizers, potassium salts, potash, micronutrients, and physical blends of any of the preceding fertilizers can be used. Fertilizer application can be surface broadcasted or sub-surface incorporated, and can be applied before, during, and/or after planting of one or more crops.

Some aspects of the invention include an agriculturally active composition comprising, at least one inhibitor of nitrification, a particulate, and a polymeric volatilization-reducing barrier, wherein the volatilization-reducing barrier reduces the rate at which the at least one inhibitor of nitrification is lost from the composition. In some embodiments, the polymeric volatilization-reducing barrier includes at least one compound selected from the group consisting of: polyvinyl alcohol (“PVA”), polyethylene oxide (“PEO”), polyvinyl pyrollidone (“PVP”), polyvinyl acetate, and mixtures thereof. In other embodiments, the polymeric volatilization-reducing barrier includes polyvinyl alcohol. Still in other embodiments, the polymeric volatilization-reducing barrier is configured to release the at least one inhibitor of nitrification upon contacting moisture after application to a field or crop.

In other embodiments, the composition includes nitrapyrin. Still in yet other embodiments, the composition comprises nitrapyrin in a range selected from the group of ranges consisting of: about 0.01% wt. to about 10.00% wt.; about 0.05% wt. to about 5.00% wt.; about 0.10% wt. to about 4.00% wt.; about 0.20% wt. to about 3.00% wt.; about 0.30% wt. to about 2.50% wt.; about 0.40% wt. to about 2.00% wt.; and about 0.50% wt. to about 1.00% wt. Still in other embodiments, the particulate comprises at least one agricultural active compound selected from the group consisting of: fertilizers, pesticides, fungicides, miticides, herbicides, arthropocides, safeners, pesticides, and mixtures thereof.

In other embodiments, at least one agricultural active compound is a fertilizer selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof. Still in other embodiments, at least one agricultural active compound is a urea fertilizer.

In yet other embodiments, the polymeric volatilization-reducing barrier reduces the volatility of the at least one inhibitor of nitrification to a diffusion constant less than about 1 μm²/s. Still in other embodiments, the polymeric volatilization-reducing barrier reduces the volatility of the at least one inhibitor of nitrification to a diffusion constant less than about 0.1 μm²/s. In other embodiments, the polymeric volatilization-reducing barrier reduces the volatility of the at least one inhibitor of nitrification to a diffusion constant less than about 0.01 μm²/s. Still in other embodiments, the polymeric volatilization-reducing barrier reduces the volatility of the at least one inhibitor of nitrification to a diffusion constant of about 0.001 μm²/s.

In some embodiments, the composition further comprises an inert filler. In other embodiments, the inert filler is at least one compound selected from the group consisting of: attapulgite, talc, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof. In some embodiments, the composition further comprises microencapsulated nitrapyrin particles, wherein the microencapsulated nitrapyrin is substantially contained within the polymeric volatilization-reducing barrier.

In yet other embodiments, the microencapsulated particles include polyurea and have a volume median particle size of from about 1 to about 10 microns.

Additionally disclosed is a method for manufacturing an agricultural active composition comprising the steps of providing at least one inhibitor of nitrification, combining the at least one inhibitor of nitrification with a particulate, and utilizing a polymeric volatilization-reducing barrier to reduce the volatility of the at least one inhibitor of nitrification. In some embodiments of the method, the polymeric volatilization-reducing barrier includes at least one compound selected from the group consisting of: polyvinyl alcohol (“PVA”), polyethylene oxide (“PEO”), polyvinyl pyrollidone (“PVP”), polyvinyl acetate, and mixtures thereof. In other embodiments of the method, the step of utilizing a polymeric volatilization-reducing barrier to reduce the volatility of the at least one inhibitor of nitrification further comprises incorporating polyvinyl alcohol into the polymeric volatilization-reducing barrier.

In some embodiments, the polymeric volatilization-reducing barrier is configured to release the at least one inhibitor of nitrification upon contacting a sufficient level of moisture after application to a field or crop. In yet other embodiments, the method further comprises the step of incorporating nitrapyrin into the composition. In still other embodiments, the method comprises adding nitrapyrin in a range selected from the group of ranges consisting of: about 0.01% wt. to about 10.00% wt.; about 0.05% wt. to about 5.00% wt.; about 0.10% wt. to about 4.00% wt.; about 0.20 wt. to about 3.00% wt.; about 0.30% wt. to about 2.50% wt.; about 0.40% wt. to about 2.00% wt.; and about 0.50, wt. to about 1.00% wt.

In yet still other embodiments, the method further comprises the step of incorporating at least one agricultural active compound selected from the group consisting of: fertilizers, fungicides, miticides, herbicides, arthropocides, safeners, pesticides, and mixtures thereof. In some embodiments of the method, at least one agricultural active compound is a fertilizer selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

In still other embodiments, at least one agricultural active compound is a urea fertilizer. Still in some embodiments, the polymeric volatilization-reducing barrier is configured to reduce the volatility of the at least one inhibitor of nitrification to a diffusion constant less than about 1 μm²/s. In other embodiments, the polymeric volatilization-reducing barrier is configured to reduce the volatility of the at least one inhibitor of nitrification to a diffusion constant less than about 0.1 μm²/s. In some embodiments, the polymeric volatilization-reducing barrier is configured to reduce the volatility of the at least one inhibitor of nitrification to a diffusion constant less than about 0.01 μm²/s.

In some embodiments, the polymeric volatilization-reducing barrier is configured to reduce the volatility of the at least one inhibitor of nitrification to a diffusion constant of about 0.001 μm²/s. In other embodiments, the method further comprises the step of adding an inert filler to the composition. In some embodiments, the inert filler is selected from the group consisting of: attapulgite, talc, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof.

Still in other embodiments, the method further comprises the step of incorporating microencapsulated nitrapyrin particles into the composition, wherein the microencapsulated nitrapyrin is substantially contained within the polymeric volatilization-reducing barrier. In yet other embodiments, the microencapsulated particles include polyurea and have a volume median particle size of from about 1 to about 10 microns. Still in some embodiments, the method further comprises the step of measuring the diffusion constant of the composition according to Fick's second law of diffusion.

Some aspects of the invention include methods for manufacturing an agricultural active composition comprising the steps of: providing at least one particle, the particle having an outer surface; supplying at least one inhibitor of nitrification; associating the at least one inhibitor of nitrification with at least a portion of the surface of the particle to form a mixed particulate, the mixed particulate having a mixed particulate surface which includes the at least one inhibitor of nitrification; and coating the mixed particulate surface with a polymeric volatilization barrier. In some embodiments the mixed particulate coated with the polymeric volatilization barrier exhibits reduced volatility of the material in the particle and the material such as nitrapyrin or formulations of nitrapyrin comprising the inhibitor of nitrification.

In some embodiments, the method further comprises the step of utilizing at least one device selected from the group consisting of: a pan coater, a spray coater, a fluidized bed coater, a rotating drum, a drier, and mixtures thereof.

In some embodiments, the method further comprises the steps of coating nitrapyrin onto an inert substrate and coating a polymeric volatilization-reducing barrier containing polyvinyl alcohol on top of the nitrapyrin. Still in other embodiments, the inert substrate is selected from the group consisting of: attapulgite, talc, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof.

In some embodiments, the method further comprises the steps of coating nitrapyrin onto an agriculturally active substrate and coating a polymeric volatilization-reducing barrier which includes polyvinyl alcohol on top of the nitrapyrin. In other embodiments, the agriculturally active substrate is selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

In some embodiments of the method, the steps further comprise forming a tablet or pellet comprising at least one nitrification inhibitor and one inert substrate and coating a polymeric volatilization-reducing barrier which includes polyvinyl alcohol on top of the tablet. In other embodiments, the at least one nitrification inhibitor includes nitrapyrin. In still other embodiments, the at least one inert substrate is selected from the group consisting of: attapulgite, talc, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof.

In yet other embodiments of the method, the steps further comprise forming a tablet or pellet comprising at least one nitrification inhibitor and at least one agriculturally active substrate and a coating comprising a polymeric volatilization-reducing barrier which includes polyvinyl alcohol wherein polymeric volatilization-reducing barrier is substantially applied to outer surface of the composition. In some embodiments, the at least one nitrification inhibitor includes nitrapyrin. Still in other embodiments, the at least one agricultural active substrate is selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

In other embodiments of the method, the steps comprise emulsifying nitrapyrin in an aqueous solution comprising nitrapyrin and polyvinyl alcohol, spraying the aqueous solution onto at least one inert substrate, and allowing rapid drying of the polyvinyl alcohol to encapsulate the nitrapyrin.

In still other embodiments of the method, the steps further comprise, emulsifying nitrapyrin in an aqueous solution comprising nitrapyrin and polyvinyl alcohol, spraying the aqueous solution onto at least one agriculturally active substrate, and allowing aqueous solution to rapid dry such that the polyvinyl alcohol encapsulates the nitrapyrin.

Still in other embodiments of the method, the steps further comprise, adding a volatilization-reducing reducing barrier to a liquid emulsion comprising at least one microencapsulated nitrification inhibitor to form a liquid formulation and spray drying the liquid formulation such that the polymeric volatilization-reducing barrier substantially coats the microencapsulated nitrification inhibitor. In some embodiments, the polymeric volatilization-reducing barrier comprises polyvinyl alcohol. In still other embodiments, the polyvinyl alcohol comprises between about 1 and about 20 percent by weight of the liquid formulation.

In yet other embodiments, the polyvinyl alcohol comprises about 10 percent by weight of the liquid formulation. Still in other embodiments, the at least one microencapsulated nitrification inhibitor comprises nitrapyrin.

### BRIEF DESCRIPTION OF THE FIGURES

The features of this disclosure, and the manner of attaining them, will become more apparent and the disclosure itself will be better understood by reference to the following description of embodiments of the disclosure taken in conjunction with the accompanying drawings.

FIG. 1 provides a schematic view of the dimensions of the diamond attenuated total reflectance (“ATR”) accessory utilized in the diffusion studies of the present disclosure.

FIG. 2 provides a schematic view of the diffusion system used in some of the diffusion studies presented herein.

FIG. 3 provides a partial differential equation (“PDE”), the boundary conditions (“BC”), and initial condition (“IC”) for modeling some of the experiments of the present disclosure.

FIG. 4 provides the analytical solution to the PDE in FIG. 3.

FIG. 5 provides the result of taking the integral of the analytical solution of FIG. 4 over the spatial range between z=0 and z=z_{d}, which provides the concentration of the active in the region near the sensor, in the region between z=0 and Z=z_{d}. λₙ and Aₙ are given in FIG. 4.

FIG. 6 provides a graph for the evolution of the nitrapyrin signal in a film of PVA at 5.5 μm. The time is measured in seconds and the concentration is measured in absorbance units relative to a measured baseline.

FIG. 7 provides a graph for the evolution of the nitrapyrin signal from a film of PEO at 10 μm. Time is measured in seconds and concentration is measured in absorbance units relative to a measured baseline.

FIG. 8 provides a graph for the evolution of the nitrapyrin signal in a film of PVP K90 at 31 μm. Time is measured in seconds and concentration is measured in absorbance units relative to a measured baseline.

FIG. 9 provides a graph for the evolution of the nitrapyrin signal in a film of Kollidon VA 64 at 30 μm. Time is measured in seconds and concentration is measured in absorbance units relative to a measured baseline.

FIG. 10 provides a graph for the summary of calculated diffusion constants for Kollidon VA64, Mowiol 4-88, PEO, and PVP K90, units in μm²/s.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION

(Trichloromethyl)pyridine compounds useful in the composition of the present disclosure include compounds having a pyridine ring which is substituted with at least one trichloromethyl group and mineral acid salts thereof. Suitable compounds include those containing chlorine or methyl substituents on the pyridine ring in addition to a trichloromethyl group, and are inclusive of chlorination products of methyl pyridines such as lutidine, collidine and picoline. Suitable salts include hydrochlorides, nitrates, sulfates and phosphates. The (trichloromethyl)pyridine compounds useful in the practice of the present disclosure are typically oily liquids or crystalline solids dissolved in a solvent. Other suitable compounds are described in U.S. Pat. No. 3,135,594. A preferred (trichloromethyl)pyridine is 2-chloro-6-(trichloromethyl)pyridine, also known as nitrapyrin, and the active ingredient of the product N-SERVE™. (Trademark of Dow AgroSciences LLC).

In some embodiments of the present disclosure, in order to measure the diffusion of nitrification inhibitors through volatilization barriers and, therefore, provide diffusion constants to estimate the ultimate loss of nitrification inhibitors to volatilization, Fourier transform infrared spectroscopy operating in attenuated total reflectance mode (“ATR-FTIR”) can be employed to probe diffusion of nitrification inhibitors, such as, for example, nitrapyrin, through polymeric materials.

Such a method for measuring diffusion through polymeric barriers in some embodiments is used with encapsulated fertilizers, fungicides, miticides, herbicides, arthropocides, safeners, pesticides, and/or any other agricultural active ingredients.

Nitrification inhibitors can be formulated within volatilization-reducing barriers in a variety of methods. In some exemplary embodiments that follow, nitrapyrin is used as an exemplary nitrification inhibitor, and polyvinyl alcohol (“PVA”) is used as an exemplary volatilization-reducing barrier. It is understood that a given volatilization barrier may not completely reduce volatilization, it may simply reduce volatilization to a more desirable level. Persons of ordinary skill in the art will understand the exemplary embodiments not to be limiting, and any suitable nitrification inhibitor and any suitable volatilization barrier can be used. Suitable nitrification inhibitors would include any nitrification inhibitor that is effective at inhibiting nitrification in a field and/or crop. Suitable volatilization barriers would include any compound that is capable of reducing the volatilization of suitable nitrification inhibitors in manufacturing, processing, storage, and/or use in a field, crop, and/or soil, and that is also capable of releasing the nitrification inhibitor upon contacting an appropriate amount of moisture.

In some exemplary embodiments, nitrapyrin is coated onto an inert substrate such as, for example, sand and/or clay. Then, a volatilization barrier such as PVA is coated on top of the nitrapyrin. Devices for use in such coating processes could include, for example, a pan coater, a spray coater, a fluidized bed coater, a rotating drum, and/or other coating devices appropriate to the nitrification inhibitor and/or inert material.

In other exemplary embodiments, nitrapyrin is coated onto an agriculturally active substrate, such as, for example, urea granules, and is then coated with PVA or another volatilization barrier applied on top of the nitrapyrin. Exemplary devices similar to those above may be used in the process.

In some exemplary embodiments, a solid form of nitrapyrin is manufactured, or a tablet or pellet of nitrapyrin is mixed with an inert filler (such as, for example, clay, starch, and/or polymer) to form a tablet or pellet that includes both nitrapyrin and the filler. The tablet or pellet that includes both nitrapyrin and the filler is coated with PVA.

In other exemplary embodiments a mixture which includes an aqueous emulsion of nitrapyrin and polyvinyl alcohol is formed. The mixture is sprayed onto an inert substrate such as, for example, sand and/or clay, and then the coated substrate is allowed to dry rapidly, allowing the PVA to encapsulate the complex of nitrapyrin and substrate. In some embodiments, the exemplary devices such as to the devices discussed in the above, or equivalent devices, may be used to practice this process.

In another exemplary embodiment, an emulsion that includes nitrapyrin is formed and the nitrapyrin rich emulsion is mixed with a solution that includes polyvinyl alcohol. The mixture of emulsified nitrapyrin and PVA is sprayed onto the surface of an agriculturally active substrate, such as, for example, urea granules, to form a coating of nitrapyrin and PVA substantially on the outside of agricultural active substrate. The coated substrate is allowed to rapidly dry for the PVA to encapsulate the nitrapyrin around the substrate. Exemplary devices similar to those above may be used in the process.

In other exemplary embodiments, a commercially available liquid emulsion or capsule suspension of microencapsulated nitrapyrin (such as, for example, Instinct® or Entrench® by Dow AgroSciences LLC) is combined with PVA or with a solution that includes PVA to form a mixture. The mixture is spray dried such that a coating of PVA forms on the surfaces of microcapsules of nitrapyrin. In some embodiments, before spray drying, the mixture includes between about 10 percent by weight and about 50 percent by weight PVA. In other embodiments, before spray drying the mixture is about 10 percent by weight PVA.

In other exemplary embodiments, nitrapyrin is combined with PVA to form a mixture which includes these components. The mixture is subjected to a hot melt extrusion at a temperature of about 140° C. or less. After hot melt extrusion, the extruded material is allowed to cool to form a solid. The resulting solid composition is granulated to form granules at any size suitable for use in agriculture.

In some embodiments of the present disclosure, any suitable dry fertilizer for application to fields and/or crops, such as, for example, a nitrogen-containing fertilizer such as urea is used in combination with encapsulation to reduce nitrification. In some embodiments, any other agricultural active ingredient including, but not limited to, fungicides, herbicides, miticides, insecticides, safeners, and arthropocides and mixtures thereof can be used in combination with any other agricultural active for encapsulation with a nitrification inhibitor.

In some embodiments, at least one of a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof and/or any blend or mixture of the foregoing are used in the compositions of the present disclosure.

In some embodiments, the volume median particle size of particles comprising the compositions of the present disclosure is similar to the size of commercially available dry fertilizer products, such as between about 0.1 mm to about 10 mm, preferably from about 0.1 mm to about 7 mm, and more preferably from about 0.1 mm to about 5 mm, and for nitrogen-based fertilizers, such as, for example, urea between about 0.3 mm and about 3 mm.

In some embodiments of the present disclosure, a volatilization inhibiting (“VI”) layer is formed by an encapsulating material, such as, for example, PVA. In some embodiments, the VI layer may wholly cover granules or particles of the compositions of the present disclosure. In other embodiments, the VI layer may not wholly cover the granules or particles of the presently disclosed compositions. For example, in some embodiments, portions of granules or particles may be open to the atmosphere where the VI layer is discontinuous. Moreover, VI layers may include at least one nitrification inhibiting active ingredient, such as, for example, nitrapyrin. In some embodiments, the VI layer includes microcapsules comprising nitrapyrin. Such microcapsules can be those microcapsules disclosed and claimed in U.S. Pat. No. 8,377,849 and U.S. Pat. No. 8,741,805. In some embodiments, the microcapsules include polyurea and are between about 1 μm and about 10 μm in size.

VI layers may optionally include any aqueous, oil-based, and/or polymeric substance, which reduce the volatilization of at least one nitrification inhibiting compound, such as nitrapyrin. Exemplary optional binders suitable for use with VI layers include, but are not limited to hydroxypropyl methylcellulose (“HPMC”), ethyl cellulose (“EC”), methyl cellulose (“MC”), carboxymethyl cellulose (“CMC”), polyvinyl alcohol (“PVA”), polyvinylpyrrolidone (“PVP”), polyoxyethylene and its copolymers, latexes, polyamides, sugar, glucose, maltose, starch, lignosulfonates, guar, urea, alginate, polysaccharides, aqueous polyester, polyethers, epoxy resin, isocyanates, ethylene vinyl acetate copolymer, polyacrylate and its copolymer emulsions, water-soluble agricultural active ingredients in aqueous solvent, oil-soluble agricultural active ingredients in oil solvent, and mixtures thereof.

Any optional binder is envisioned for use in the presently disclosed compositions that is capable of forming one or more VI layers around the outer surface of a granule or particle and is capable of dissolving and/or releasing the nitrapyrin, which in some embodiments is microencapsulated, and an agricultural active core, in some embodiments fertilizer, once placed in a field or crop. The optional binder can be used to help immobilize nitrification inhibitors, optionally encapsulated nitrapyrin, around a core particle, such as a granule (for example an inert substrate or agriculturally active compounds, such as for example, urea fertilizer granules). The binder can also help to adhere particulates, such as hygroscopic particulate or other volatilization barrier material, around the VI layer. Furthermore, binder may be used to adjust the formulation's viscosity and/or flowability.

In some embodiments, hygroscopic particulate (“HP”) or similar material is used to help form one or more volatilization barriers. Such materials can include, but are not limited to, one or more of attapulgite, talc powder, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof. Any material is envisioned as being used for a HP, so long as the material can be incorporated into the compositions of the present disclosure to limit volatilization of nitrapyrin during manufacturing, processing, storage, and/or preparation, but allow for the release of nitrapyrin when the compositions come in contact with an appropriate amount of moisture.

Hygroscopic particulate, in some embodiments, serves as a drying agent to avoid core particle agglomeration, which may be caused by sticking between the volatilization inhibitor layers of different core particles. The particulate can also serve as a protectant for the volatilization inhibiting layer, optionally containing encapsulated nitrapyrin, by preventing the nitrification inhibitor from peeling away from the core particle by mechanical abrasion. The hygroscopic particulate, in some embodiments, serves as a layer of protection to reduce the sensitivity of the combined particles to the environment, such as the environment during processing, storage, shipping, and use. In some embodiments, the hygroscopic particulate aids in reducing the volatility of the core particle and/or the nitrification inhibitor(s).

Any portion of the compositions of the present disclosure may contain any other physically compatible agricultural active ingredient including, but not limited to, fungicides, herbicides, miticides, insecticides, safeners, arthropocides, and mixtures or blends of any of the foregoing. Physically compatible agricultural active ingredients include any AI that can be formulated with the compositions of the present disclosure for stable storage, transport, and distribution to a field and for suitable, consistent release of the granules and/or particles to the soil, field, and/or crop.

In some embodiments, microencapsulated nitrapyrin particles, encapsulated with polyurea, are coated on the surface of urea or other dry fertilizer granules/particles, for use in fields and/or crops. In some embodiments, the compositions of the present disclosure are dry formulations. In some embodiments, the VI layer, optionally including one or more binders or one or more types of hygroscopic particulate, will dissolve in water (in soil conditions) and then release encapsulated nitrapyrin. Nitrapyrin will then diffuse into the soil to function as an inhibitor for nitrification of AI's, optionally nitrogen-containing fertilizers.

One or more binder solutions or coating liquids may be incorporated into the compositions of the present disclosure, such as a combination of HPMC and PVA. In other embodiments, the binder solution or coating liquid may comprise only one polymeric binder, multiple polymeric binders, or no polymeric binders. In some embodiments, following the preparation of a binder solution or coating liquid with polymeric binders, a water suspension of encapsulated nitrapyrin (such as, for example, Entrench® and/or Instinct® by Dow AgroSciences LLC) is mixed with the binder solution or coating liquid at room temperature. Optionally, one or more agriculturally active ingredients, such as urea granules, can also be added to the binder solution, optionally with water or other solvents, such as oil, to dissolve the one or more agricultural active ingredients in the binder solution.

In some embodiments, a water suspension of encapsulated nitrapyrin (such as, for example, Entrench® and/or Instinct® by Dow AgroSciences LLC) is mixed with one or more water-soluble agriculturally active ingredients dissolved in aqueous solution and/or one or more oil-soluble agriculturally active ingredients dissolved in oil solvent to form a coating liquid, without any polymeric binder. In some embodiments, the dissolved agriculturally active ingredient is the same as the agricultural active ingredient to be coated in a granule form. In other embodiments, the dissolved agriculturally active ingredient is different than the agricultural active ingredient to be coated in a granule form.

In some embodiments, the final suspension including the binder solution, one or more agricultural actives, one or more solvents, and the water suspension of encapsulated nitrapyrin is mixed for an additional period of time, preferably about 2 hours, prior to coating a particle or granule composition.

Granules or particles of the present disclosure can be coated by binder solutions or coating liquids optionally inside a pan coater with a rotating drum. Other coating devices known in the art could also be used. A prescribed amount of bare granules or particles are first charged into a coater. Then, a suspension including the binder solution is added to the pan coater and/or sprayed onto the granules. In one embodiment, the pan speed is kept at 60 rpm during the coating process. After addition of one or more suspensions, the coater is kept rotating, preferably for between about 5 and about 30 minutes.

In some embodiments, after a VI layer is added to the compositions of the present disclosure, a hygroscopic particulate layer can be applied to the VI layer. For instance, after a coating liquid is evenly coated on a granule or particle, HP powder, such as for example, talc or diatomaceous earth, can be added to the pan coater under rotation. After addition of the HP, the pan can be kept rotating, preferably for about 10 minutes, to allow the HP to evenly coat the VI layer. One or more of such powders can comprise the HP layer. An HP layer can be continuous or discontinuous around the VI layer, and/or can be substantially embedded within the VI layer. Equipment that can be used to prepare compositions of the present disclosure include, but is not limited to a pan coater, a rotating drum, a spray coater, a fluid bed, and/or screens.

Compositions of the present disclosure can be dried, preferably at about 20 to about 80 degrees Celsius for about 10 to about 60 minutes to remove water and obtain the final dry combined particles. Alternatively, drying may be omitted. The coated fertilizer comprising combined particles can be applied without additional drying.

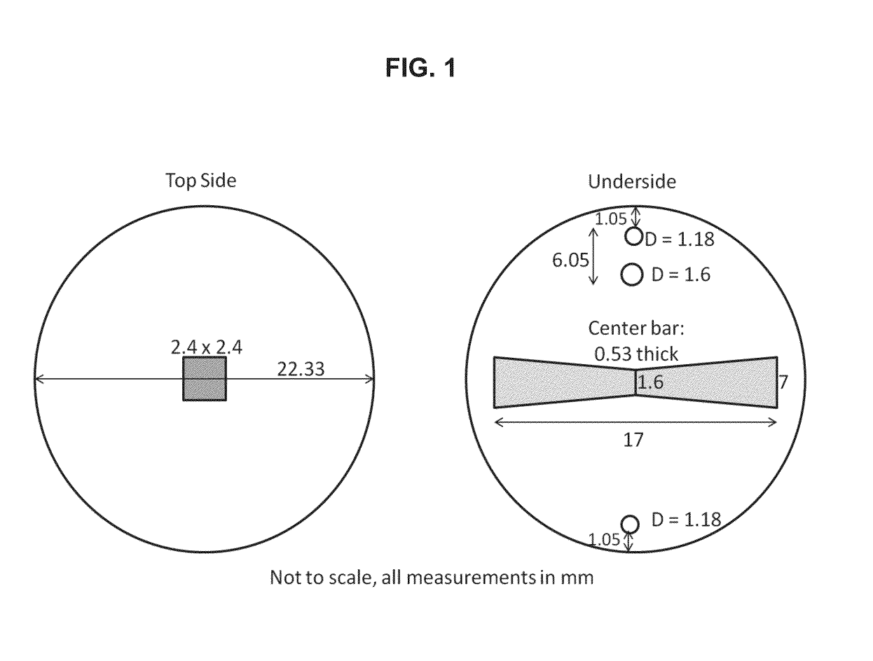

Referring now to FIG. 1, a perspective view of the dimensions of the diamond attenuated total reflectance (“ATR”) accessory utilized in the diffusion studies of the present disclosure is provided.

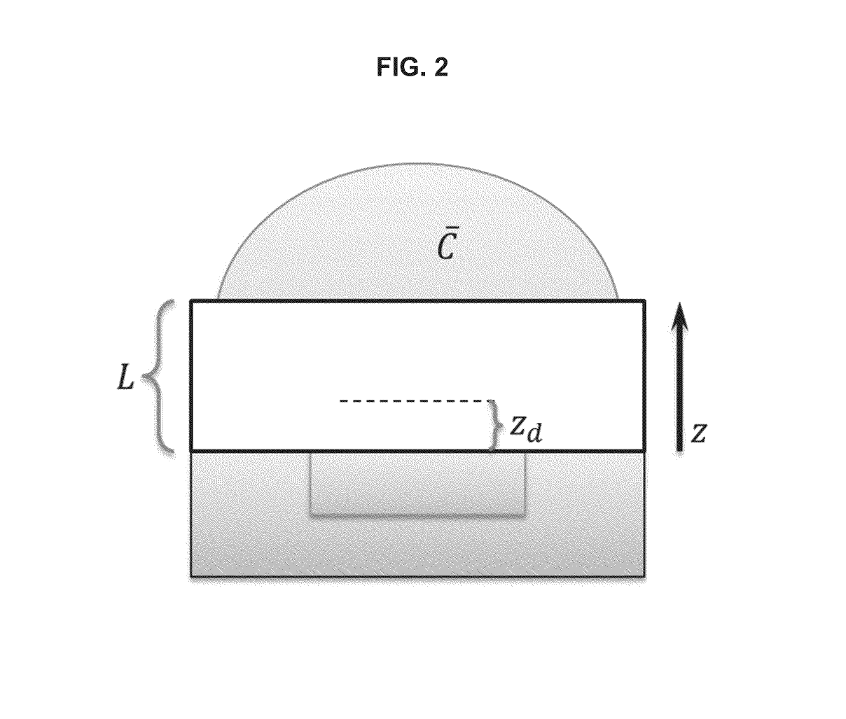

FIG. 2 provides a schematic of the diffusion system considered as a model for the diffusion studies of the present disclosure.

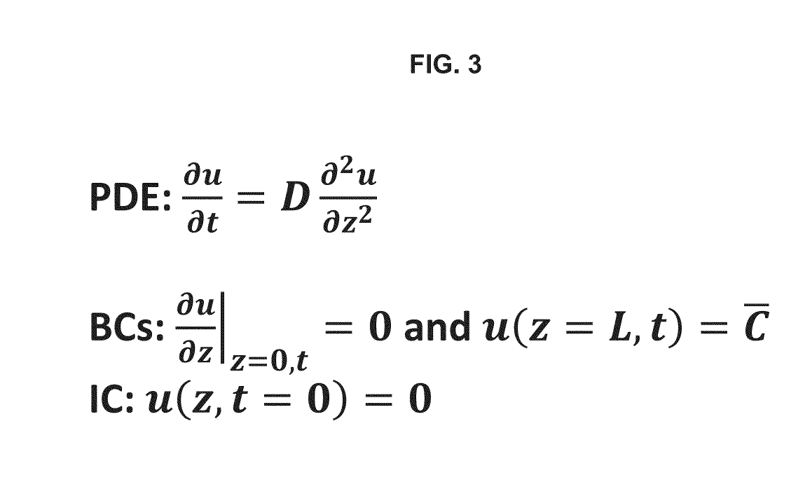

Referring now to FIG. 3, the partial differential equation (“PDE”), the boundary conditions (“BC”), and initial condition (“IC”) for modeling in the experiments of the present disclosure are shown.

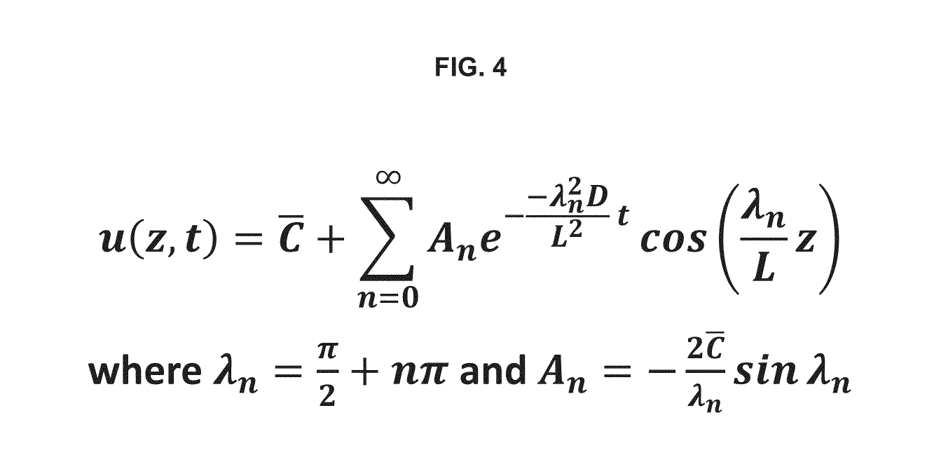

FIG. 4 provides the analytical solution to the PDE in FIG. 3.

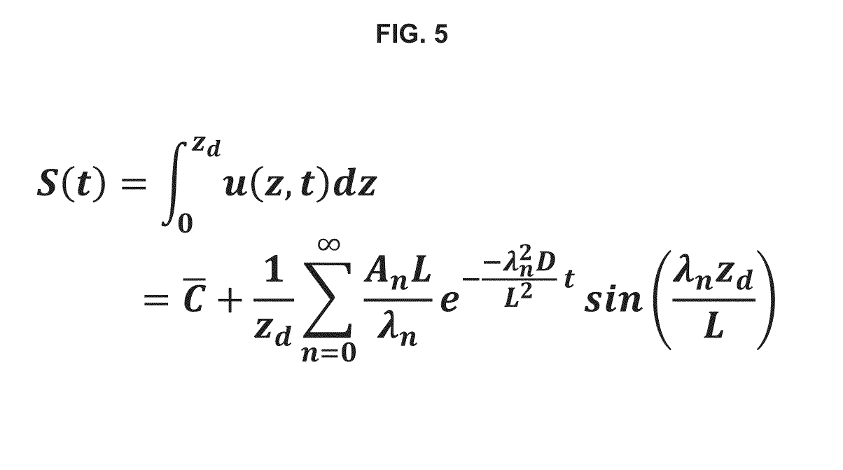

Referring now to FIG. 5, the result is provided from taking the integral of the analytical solution of FIG. 4 over the spatial range between z=0 and z=z_{d}, which provides the concentration of the active in the region near the sensor, in the region between z=0 and z=z_{d}. λₙ and Aₙ are given in FIG. 4.

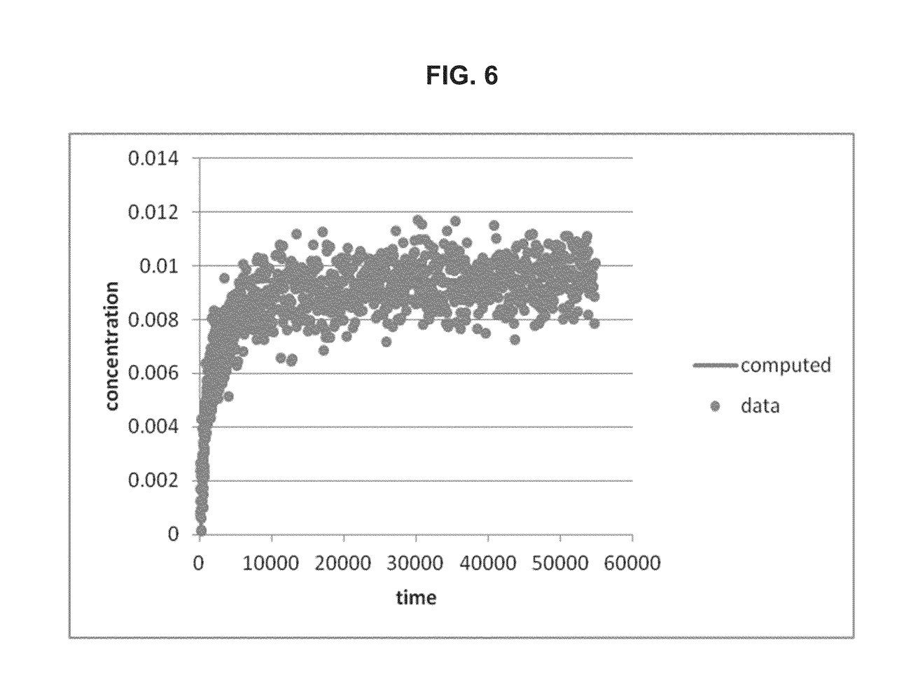

FIG. 6 is a graph of data determined by measuring the evolution of the nitrapyrin signal in a film of PVA at 5.5 μm. Time is measured in seconds and concentration is measured in absorbance units relative to a measured baseline.

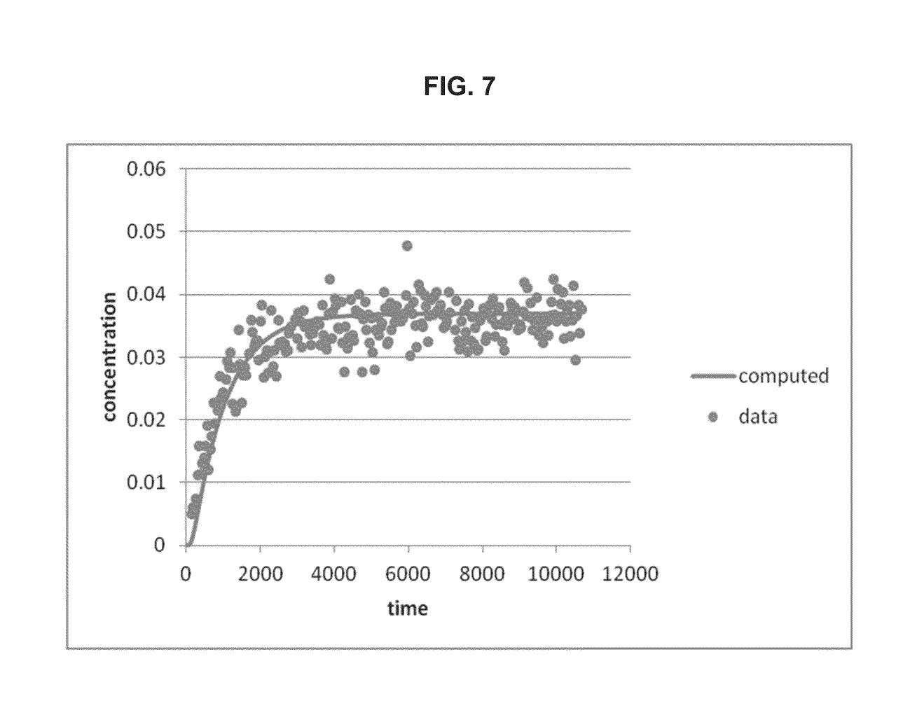

Referring now to FIG. 7, a graph of data determined by measuring the evolution of the nitrapyrin signal in a film of PEO at 10 μm is shown. Time is measured in seconds and concentration is measured in absorbance units relative to a measured baseline.

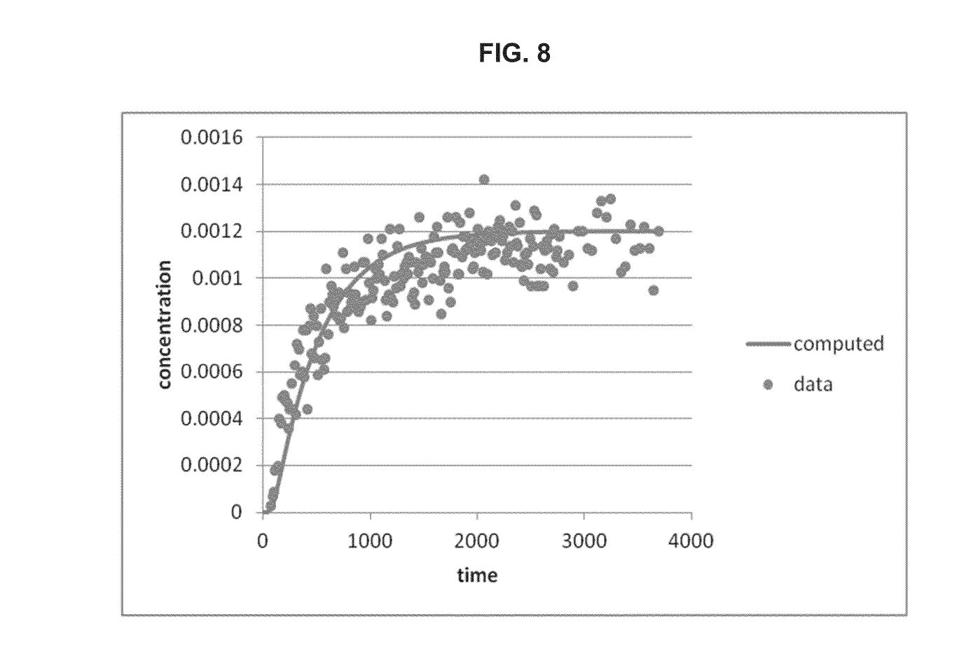

FIG. 8 provides a graph of data collected by measuring the evolution of the nitrapyrin signal in a film of PVP K90 at 31 μm; time is measured in seconds and concentration is measured in absorbance units relative to a measured baseline.

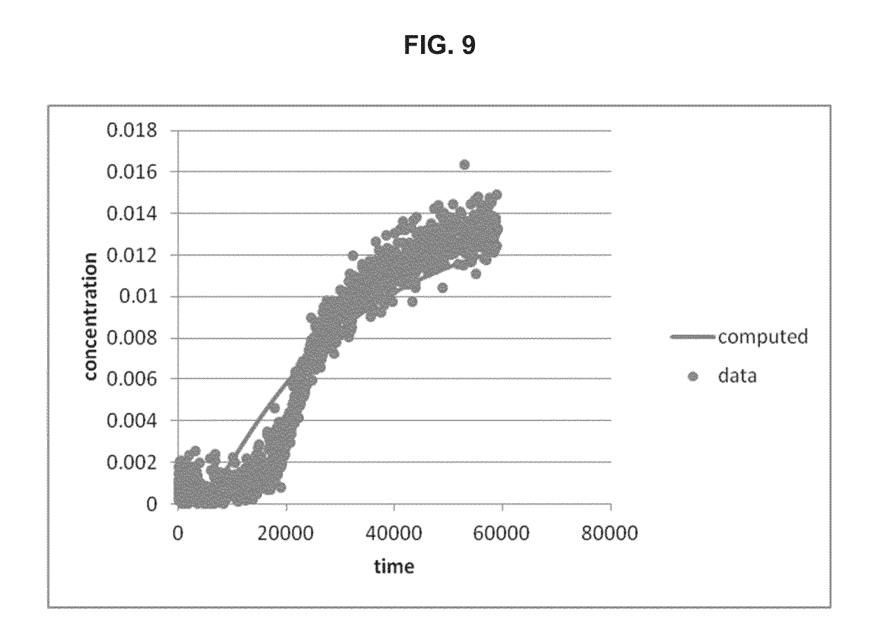

FIG. 9 provides a graph of data collected by measuring the evolution of the nitrapyrin signal in a film of Kollidon VA 64 at 30 μm; time is measured in seconds and concentration is measured in absorbance units relative to a measured baseline.

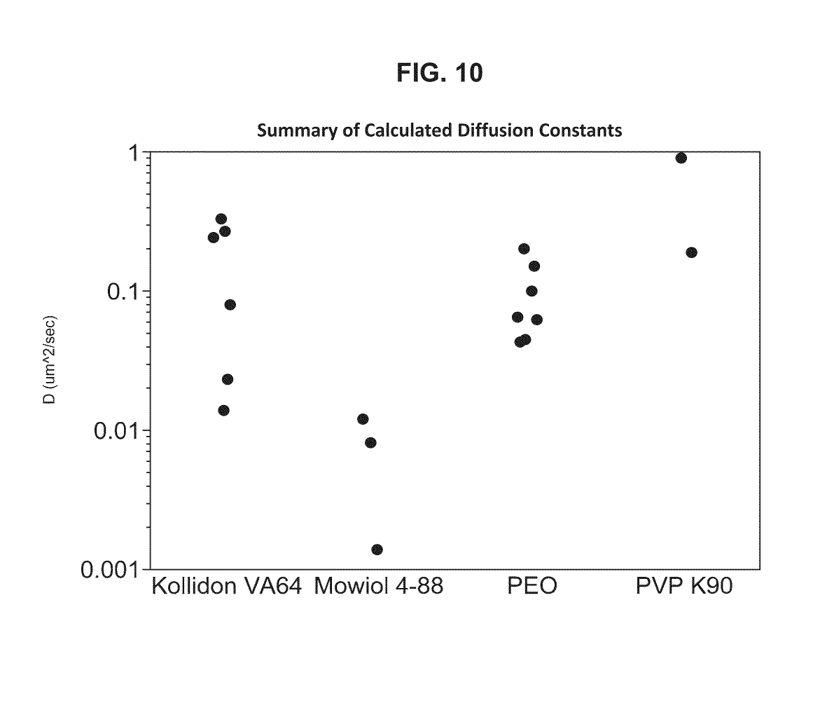

FIG. 10 is a graphical representation of the calculated diffusion constants for Kollidon VA64, Mowiol 4-88, PEO, and PVP K90, units in μm²/s.

Examples of typical solvents which can be used to dissolve crystalline (trichloromethyl)pyridine compounds include aromatic solvents, particularly alkyl substituted benzenes such as xylene or propylbenzene fractions, and mixed naphthalene and alkyl naphthalene fractions; mineral oils; kerosene; dialkyl amides of fatty acids, particularly the dimethylamides of fatty acids such as the dimethyl amide of caprylic acid; chlorinated aliphatic and aromatic hydrocarbons such as 1,1,1-trichloroethane and chlorobenzene, esters of glycol derivatives, such as the acetate of the n-butyl, ethyl, or methyl ether of diethyleneglycol and the acetate of the methyl ether of dipropylene glycol; ketones such as isophorone and trimethylcyclohexanone (dihydroisophorone); and the acetate products such as hexyl or heptyl acetate. The preferred organic liquids are xylene, alkyl substituted benzenes, such as propyl benzene fractions, and alkyl naphthalene fractions.

In general, if solvent is used, it is present in the amount of from about 40, preferably from about 50 to about 70, preferably to about 60 weight percent, based on the total weight of a (trichloromethyl) pyridine/solvent solution. The amount of (trichloromethyl) pyridine within a (trichloromethyl) pyridine/solvent solution is typically from about 30, preferably from about 40 to about 60, preferably to about 50 weight percent, based on the weight of a (trichloromethyl) pyridine/solvent solution. In some embodiments of the present disclosure, nitrapyrin technical can be used in the formulation of the composition. Nitrapyrin technical comprises about 90% to about 100% pure nitrapyrin depending on the impurity level. Therefore, in some embodiments the amount of solvent employed might be about 0% to about 10%, while the amount of nitrapyrin technical might be about 90% to about 100% pure.

In some embodiments which include microcapsules of nitrapyrin, the microcapsules can be prepared by the polycondensation reaction of a polymeric isocyanate and a polyamine to form a polyurea shell. Methods of microencapsulation are well known in the art and any such method can be utilized in the present disclosure to provide a capsule suspension formulation. In general, the capsule suspension formulation can be prepared by first mixing a polymeric isocyanate with a (trichloromethyl)pyridine/solvent solution. This mixture is then combined with an aqueous phase which includes an emulsifier to form a two phase system. The organic phase is emulsified into the aqueous phase by shearing until the desired particle size is achieved. An aqueous crosslinking polyamine solution is then added drop-wise while stirring to form the encapsulated particles of (trichloromethyl)pyridine in an aqueous suspension.

The desired particle size and cell wall thickness will depend upon the actual application. The microcapsules typically have a volume median particle size of from about 1 to about 10 microns and a capsule wall thickness of from about 10 to about 125 nanometers. In some embodiments, the microcapsules have a volume median particle size of from about 1 to about 10 microns and a capsule wall thickness of from about 10 to about 150 nanometers. In one embodiment, the desired particle size may be from about 2 to about 10 microns, with a cell wall thickness of from about 10 to about 50 nanometers. In some embodiments, the desired particle size may be from about 2 to about 10 microns, with a cell wall thickness of from about 10 to about 25 nanometers.

In one embodiment, particularly requiring soil surface stability, the desired particle size may be from about 1-5 microns, with cell wall thicknesses of from about 50 to about 150 nanometers. In another embodiment, particularly requiring soil surface stability, the desired particle size may be from about 1-5 microns, with cell wall thicknesses of from about 75 to about 125 nanometers.

Other conventional additives may also be incorporated into the formulation such as emulsifiers, dispersants, thickeners, biocides, pesticides, salts and film-forming polymers.

Dispersing and emulsifying agents include condensation products of alkylene oxides with phenols and organic acids, alkyl aryl sulfonates, polyoxyalkylene derivatives of sorbitan esters, complex ether alcohols, mahogany soaps, lignin sulfonates, polyvinyl alcohols, and the like. The surface-active agents are generally employed in the amount of from about 1 to about 20 percent by weight of the microcapsule suspension formulation.

The ratio of the suspended phase to the aqueous phase within exemplary microcapsule suspension formulations of the present disclosure is dependent upon the desired concentration of (trichloromethyl) pyridine compound in the final formulation. Typically the ratio will be from about 1:0.60 to about 1:20. Generally the desired ratio is about 1:0.8 to about 1:9, and is preferably from about 1:0.8 to about 1:4.

The presence of a (trichloromethyl)pyridine compound suppresses the nitrification of ammonium nitrogen in the soil or growth medium, thereby preventing the rapid loss of ammonium nitrogen originating from nitrogen fertilizers, organic nitrogen constituents, or organic fertilizers and the like.

The enhanced nitrification inhibitor dry fertilizer compositions of the present disclosure can be applied in any manner which will benefit the crop of interest. In one embodiment the enhanced nitrification inhibitor dry fertilizer compositions are applied to growth mediums in a band or row application. In another embodiment, the compositions are applied to or throughout the growth medium prior to seeding or transplanting the desired crop plant. In yet another embodiment, the compositions can be applied to the root zone of growing plants.

Additionally, the compositions can be applied with the application of nitrogen fertilizers. The composition can be applied prior to, subsequent to, or simultaneously with the application of fertilizers.

Many of the compositions of the present disclosure have the added benefit that they can be applied to the soil surface without additional water or mechanical incorporation into the soil for days to weeks. Alternatively, if desired, the compositions of the present disclosure can be incorporated into the soil directly upon application.

The enhanced nitrification inhibitor dry fertilizer compositions of the present disclosure typically have a concentration of (trichloromethyl) pyridine compound in amounts of from about 0.01 to about 10, preferably from about 0.10 to about 5.00, and more preferably from about 0.10 to about 2.50, percent by weight, based on the total weight of the nitrification inhibitor dry fertilizer composition.

Soil treatment compositions may be prepared by dispersing the nitrification inhibitor dry fertilizer compositions in fertilizers such as ammonium or organic nitrogen fertilizer. The resulting fertilizer composition may be employed as such or may be modified, as by dilution with additional nitrogen fertilizer or with inert solid carrier to obtain a composition containing the desired amount of active agent for treatment of soil.

The soil may be prepared in any convenient fashion with the nitrification inhibitor dry fertilizer compositions of the present disclosure, including mechanically mixed with the soil; applied to the surface of the soil and thereafter dragged or diced into the soil to a desired depth; or transported into the soil such as by injection, spraying, dusting or irrigation. In irrigation applications, the nitrification inhibitor dry fertilizer composition may be introduced to irrigation water in an appropriate amount in order to obtain a distribution of the (trichloromethyl)pyridine compound to the desired depth of up to 6 inches (15.24 cm).

Due to the controlled release of nitrapyrin in the nitrification inhibitor dry fertilizer compositions of the present disclosure, several advantages can be attained. First, the amount of nitrapyrin can be reduced since it is more efficiently released into the soil over an extended period of time. Additionally, the nitrification inhibitor dry fertilizer compositions of the present disclosure can be applied and left on the surface to be naturally incorporated into the soil, without the need for mechanical incorporation if desired.

Additionally, the nitrification inhibitor dry fertilizer compositions of the present disclosure can be combined or used in conjunction with pesticides, including arthropodicides, bactericides, fungicides, herbicides, insecticides, miticides, nematicides, nitrification inhibitors such as dicyandiamide, urease inhibitors such as N-(n-butyl) thiophosphoric triamide, and the like or pesticidal mixtures and synergistic mixtures thereof. In such applications, the nitrification inhibitor dry fertilizer compositions of the present disclosure can be mixed or blended with the desired pesticide(s) or they can be applied sequentially.

Exemplary herbicides include, but are not limited to acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP. DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp' DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, vaniliprole, XMC, xylylcarb, zeta cypermethrin and zolaprofos.

Additionally, any combination of the above pesticides can be used, for example Rynaxypyr™, a anthranilic diamide (Chlorantraniliprole) crop protection chemistry available from from DuPont with efficacy in controlling target pests can be used.

The following examples are provided to illustrate some aspects of the present invention the examples disclosed herein are not intended to limit the scope of the present invention and they should not be so interpreted. Amounts are in weight parts or weight percentages unless otherwise indicated.

### Examples

A Nicolet 4700 Fourier transform infrared spectrometer (“FTIR”) with SCFGG using attenuated total reflectance (“ATR”) accessory (“Specac”) was utilized in the studies presented herein. Nitrapyrin technical grade manufactured by Dow AgroSciences LLC was used in some of the experiments presented herein. Nitrapyrin technical comprises about 900/% to about 100% pure nitrapyrin depending on the impurity level.

Referring now to FIG. 1, a perspective view of the dimensions of the diamond ATR accessory utilized in the diffusion studies of the present disclosure is provided. The crystal is diamond embedded within a tungsten carbide puck. The dimensions of the puck and photographs are show in FIG. 1. Diamond ATR accessory 100 includes top side 102, underside 104, and holes 106. Holes 106 on underside 104 facilitate alignment and fixation on ATR Accessory 100, and trapezoidal opening 108 enables beam passage into and out of the diamond crystal.

Films were cast on top of the diamond from aqueous solutions. Most of the polymers used herein were obtained from Sigma Aldrich. Gelatin was obtained from Dow AgroSciences LLC (275 Bloom Gelatin). Sorbitol Special was obtained from SPI Pharmaceutical. Gelatin solutions were prepared by heating the gelatin to about 70° C. and some films were cast while the gelatin-including solution was still heated. Other solutions were cast at room temperature.

Kollidon VA64 was purchased as a vinyl pyrrolidone/vinyl acetate 60/40 copolymer from Sigma Aldrich. Poly vinyl pyrrolidone (“K90”), gelatin, and Mowiol 4-88 (“Polyvinyl alcohol”) were cast as films via spin coating. 600 kDa polyethylene oxide and gelatin containing sorbitol special were drop cast onto the puck. All films were allowed to dry in an 80° C. oven for a minimum of two hours before use. Film thickness was measured using a Dektak profilometer (Veeco).

Nitrapyrin solutions were prepared in low molecular weight polymer oils. 20 wt. % solutions were prepared in 3 kDa poly(propylene oxide) (Polysciences) and 4.5 kDa poly(butylene oxide). Experiments were also run with a 2 wt. % solution in 10 kDa polydimethylsiloxane (“PDMS”) oil, but generally signals were too low for resolution of nitrapyrin peaks. Solutions were dried with MgSO₄ before use to remove residual water.

Films were allowed to equilibrate in the FTIR chamber for thirty minutes before the experiments were started. Four 1 oz vial lids were also placed in the FTIR chamber and filled with water to keep a constant humidity while under nitrogen flow. A single-beam spectrum was acquired of the film for use as a background spectrum, after which absorbance spectra were continuously recorded throughout the experiment. Peak heights were determined using a macro and data were fit according to the model as described below.

### Diffusion Model—Schematic of Model System

Referring now to FIG. 2, a schematic diagram illustrating the diffusion of an active compound from a droplet through a material toward a sensor of an instrument is shown. This diagram is a simplified presentation of the system disclosed by Tiwary and Drake who created a finite difference simulation of the diffusion of active through materials.

The active compound exists in a droplet of solution with a high molecular weight solvent. The concentration of the active in this solution is C̅ and is assumed not to change during the time of the experiment due to its large relative volume (˜2 orders of magnitude) compared to the diffusion layer material. The active diffuses through a material of width L. The model considers only one dimension of this diffusion, that in the −z direction. Once the material enters a region near the instrument sensor, a signal is registered. It is assumed that this distance from the sensor is z_{d}.

As shown by FIG. 2, the polymeric material of depth L is placed on a sensor. A droplet with concentration C of active is placed in contact with the polymeric material. The depth into the polymeric material that the sensor can measure is z_{d}. The lengths of the materials are not to scale and the volume of the droplet is several orders of magnitude greater than the volume of the polymeric material.

The desired output of the model is to compute the increase in concentration of the active near the sensor, in the region between z=0 and z=z_{d}. The model output will be compared to experimental data to determine the diffusion constant D of the active through the material that aligns the results.

### Model Derivation and Solution

The model is premised on the assumption that the diffusion of active through a material in the system is governed by Fick's second law of diffusion in one spatial dimension. The partial differential equation (“PDE”), the boundary conditions (“BC”), and initial condition (“IC”) are given as those shown in FIG. 3.

Referring now to FIG. 3, u(z, t) is the concentration of active at depth z and time t. The BC's are chosen to keep a constant concentration of active at the interface with the solution and to have zero flux at the boundary with the instrument. The IC states that there is no active in the material at the beginning of the experiment.

Solution methods and notation outlined in Farlow, are used to solve the partial differential equation. The methods include applying transformations to make variables dimensionless and homogenizing the BC's. The latter allows for the use of separation of variables for an analytical solution. The analytical solution to the partial differential equation shown in FIG. 3 is shown in FIG. 4.

The concentration of the active in the region near the sensor, in the region between z=0 and z=z_{d}, is found by taking the integral of the analytical solution over this spatial range. This integral gives the result shown in FIG. 5. Now referring to FIG. 5, λₙ and Aₙ are provided in FIG. 4.

Referring now to FIGS. 6-9, FIG. 6 provides the evolution of the nitrapyrin signal in a film of PVA at 5.5 μm. Referring now to FIG. 7, the evolution of the nitrapyrin signal in a polyethylene oxide film of 10 μm is shown. Referring now to FIG. 8, the evolution of the nitrapyrin signal in a polyvinyl pyrrolidone (K90) film of 10 μm is shown. Referring now to FIG. 9, the evolution of the nitrapyrin signal in a Kollidon VA64 film of 30 μm is shown. In FIGS. 6-9, time is measured in seconds, and the concentration is measured in absorbance units relative to a measured baseline.

For each experiment run that produced a measurable signal, a diffusion constant was calculated using the model. In some experiments, multiple diffusion constants were estimated to better identify a range based on the error of other parts of the measurements (i.e. film thickness, film uniformity, or baseline variability). The data are summarized as follows.

Referring now to FIG. 10, the diffusion constants for nitrapyrin through different polymer films are shown. The diffusion constants span three orders of magnitude depending on the polymer. The lowest measured partition coefficient corresponded to PVA films ranging from 10⁻³-10⁻² μm²/s. Polyethylene oxide had a rather broad range of measured diffusion constants due to film non-uniformity and use reporting multiple fits for a single film. The nitrapyrin diffusion constant for polyethylene oxide likely is closer to 4-5×10⁻² range than a 1-2×10⁻¹ μm²/s as the nitrapyrin signal can build through the shallower portions of the film faster, but modeling the diffusion profile of a film with variable thickness would be a significant challenge and undo much of the simplification that the model chose to address.

Polyvinyl pyrollidone (K90) had a very rapid diffusion constant, ranging from 0.1-1 μm²/s. The vinyl pyrollidone/vinyl acetate copolymer (Kollidon VA64) exhibited a unique diffusion profile, the curve not well-fitting a standard diffusion model. Initially, nitrapyrin evolution is slow through the film before it rapidly equilibrates. Consequently, the modeled diffusion constant very much depends on the lengths of the time lag and plateau.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

What is claimed is:

1. A method for manufacturing an agricultural active composition comprising the steps of:
providing at least one particle, the particle having an outer surface;
supplying at least one inhibitor of nitrification;
associating the at least one inhibitor of nitrification with at least a portion of the surface of the particle to form a mixed particulate, the mixed particulate having a mixed particulate surface which includes the at least one inhibitor of nitrification; and
coating the mixed particulate surface with a polymeric volatilization barrier.

2. The method according to claim 1, wherein the polymeric volatilization barrier includes at least one compound selected from the group consisting of: polyvinyl alcohol (“PVA”), polyethylene oxide (“PEO”), polyvinyl pyrollidone (“PVP”), polyvinyl acetate, and mixtures thereof.

3. The method according to claim 1, wherein the step of coating a polymeric volatilization barrier over the mixed particulate surface further comprises incorporating polyvinyl alcohol into the polymeric volatilization barrier.

4. The method according to claim 1, wherein the polymeric volatilization barrier is configured to release the at least one inhibitor of nitrification upon contacting moisture after application to a field or crop.

5. The method according to claim 1, wherein the at least one inhibitor of nitrification comprises nitrapyrin.

6. The method according to claim 5, wherein the nitrapyrin is present in the composition in a range selected from the group of ranges consisting of: about 0.01% wt. to about 10.00% wt.; about 0.05% wt. to about 5.00% wt.; about 0.10% wt. to about 4.00% wt.; about 0.20% wt. to about 3.00% wt.; about 0.30% wt. to about 2.50% wt.; about 0.40% wt. to about 2.00% wt.; and about 0.50% wt. to about 1.00% wt.

7. The method according to claim 1, wherein the at least one particle includes at least one agricultural active compound selected from the group consisting of: fertilizers, fungicides, miticides, herbicides, arthropocides, safeners, pesticides, and mixtures thereof.

8. The method according to claim 7, wherein at least one agricultural active compound is at least one fertilizer selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

9. The method according to claim 8, wherein at least one agricultural active compound is a urea fertilizer.

10. The method according to claim 1, wherein the polymeric volatilization barrier is configured to reduce the volatility of the at least one inhibitor of nitrification to a diffusion constant of less than about 1 μm²/s.

11. The method according to claim 1, wherein the polymeric volatilization barrier is configured to reduce the volatility of the at least one inhibitor of nitrification to a diffusion constant of less than about 0.1 μm²/s.

12. The method according to claim 1, wherein the polymeric volatilization barrier is configured to reduce the volatility of the at least one inhibitor of nitrification to a diffusion constant of less than about 0.01 μm²/s.

13. The method according to claim 1, wherein the polymeric volatilization barrier is configured to reduce the volatility of the at least one inhibitor of nitrification to a diffusion constant of about 0.001 μm²/s.

14. The method according to claim 1, wherein the at least one particle includes at least one inert filler.

15. The method according to claim 14, wherein the inert filler is selected from the group consisting of: attapulgite, talc, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof.

16. The method according to claim 1, further comprising the step of incorporating microencapsulated nitrapyrin particles into the composition, wherein the microencapsulated nitrapyrin is substantially contained within the polymeric volatilization barrier.

17. The method according to claim 16, wherein the microencapsulated particles include polyurea and have a volume median particle size of from about 1 to about 10 microns.

18. The method according to claim 1, further comprising the step of measuring the diffusion constant of the composition according to Fick's second law of diffusion.

19. The method according to claim 1, wherein the coating step uses at least one device selected from the group consisting of: a pan coater, a spray coater, a fluidized bed coater, a rotating drum, a drier, and combinations thereof.

20. A method for manufacturing a composition comprising the steps of:
coating nitrapyrin onto a substrate, wherein the substrate is an inert substrate or an agriculturally active substrate; and
coating a polymeric volatilization barrier containing polyvinyl alcohol on top of the nitrapyrin.

21. The method according to claim 20, wherein the inert substrate is selected from the group consisting of: attapulgite, talc, diatomite, kaolin, silica, clay, sand, mica, bentonite, montmorillonite, white carbon black, carbon black, coal ash, plant ash, wollastonite, zeolite, sepiolite, vermiculite perlite, starch, wax, and mixtures thereof.

22. The method according to claim 20, wherein the agriculturally active substrate is selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

23. The method according to claim 20, further comprising the steps of:
forming a tablet comprising the nitrapyrin and the substrate; and
coating the polymeric volatilization barrier containing polyvinyl alcohol on top of the tablet.

24. A method for manufacturing a composition comprising the steps of:
adding a polymeric volatilization barrier to a liquid emulsion comprising at least one microencapsulated nitrification inhibitor to form a liquid formulation; and
spray drying the liquid formulation such that the polymeric volatilization barrier substantially coats the microencapsulated nitrification inhibitor.

25. The method according to claim 24, wherein the polymeric volatilization barrier comprises polyvinyl alcohol.

26. The method according to claim 25, wherein the polyvinyl alcohol comprises between about 1 and about 20 percent by weight of the liquid formulation.

27. The method according to claim 25, wherein the polyvinyl alcohol comprises about 10 percent by weight of the liquid formulation.

28. The method according to claim 24, wherein the at least one microencapsulated nitrification inhibitor comprises nitrapyrin.
